(19) United States
(12) Patent Application Publication
(10) Pub. No.: US 2021/0408775 A1
(43) Pub. Date: Dec. 30, 2021

(54) TRIM COVER

(71) Applicant: Glen W. Ragland, Suches, GA (US)

(72) Inventor: Glen W. Ragland, Suches, GA (US)

(21) Appl. No.: 17/360,132

(22) Filed: Jun. 28, 2021

Related U.S. Application Data
(60) Provisional application No. 63/102,748, filed on Jun. 29, 2020.

(51) Int. Cl. H02G 3/14; H01H 23/04; H01R 13/52; H01R 13/447

(52) U.S. Cl. CPC H02G 3/14; H01R 13/447; H01R 13/5213; H01H 23/04

(57) ABSTRACT

Disclosed are various embodiments for a trim cover for electrical junction boxes. In one aspect a trim cover kit for installing electrical junction boxes to framing of a wall is disclosed. The kit includes an electrical junction box, an electrical outlet or switch with wiring and terminal screws, and a trim cover having an interior surface, an exterior surface, a distal border capable of covering the opening in the wall structure, and a proximal border with an opening for the electrical outlet. The trim cover further includes interior flashing on the sides of the proximal border to secure the trim cover within a wall structure, as well as to provide a thermal barrier, and to protect against contact with the terminal screws. The trim cover further includes one or more alignment fastener points and/or retaining screw guides for fastening the trim cover to the electrical junction box.

### CROSS-REFERENCE TO RELATED APPLICATIONS

This application claims the benefit and priority of U.S. Provisional Patent Application No. 63/102,748 filed on Jun. 29, 2020, entitled “TRIM COVER,” the contents of which is herein incorporated by reference in its entirety.

### FIELD

The present invention relates to electrical junction boxes, and specifically to gaskets and/or coverings for electrical junction boxes.

### BACKGROUND

Electrical junction boxes or junction boxes are typically mounted to the framing of a home or building and contain two or more electrical circuit cables or electric wires (e.g. lead and neutral), and ground wires. Electrical junction boxes make splicing wires and connecting fixtures to devices possible. Junction boxes are typically comprised of metal or polymeric plastic, and range from 2 ½ inches to 3 ½ inches deep. The electrical junction boxes house electrical equipment and provide the necessary routing as well as protection for containing electrical components. Typical electrical junction boxes house electrical outlets or switches, and are sized dependent on the electrical component need.

The National Electric Code (NEC) is the regionally adopted standard for the safe and correct installation of electrical wiring and equipment within the United States. The NEC specifies requirements and sets standards for the installation of electrical wiring within homes and commercial buildings. Several NEC sections are relevant to the following discussion, including NEC 314.16 Wiring Methods Junction Box Fill, and NEC 314.29 All Boxes Shall be Accessible, and NEC 314 Boxes Shall be Installed at Each Conductor Splice Point, Outlet, Switch Point, Junction Point, or Pull Point.

In the late 1800's distributed electricity began to enter commercial buildings and homes. Along with it came the invention of electrical lighting and then alternating current. Then, in 1904 Harvey Hubbell was issued U.S. Pat. No. 774,250, for the first detachable electric wall plug. Hubbell's detachable wall plug revolutionized the way electrical wires were connected to accessories. Since then many adaptations and improvements have increased the safety, and reliability, and simplified the installation process of wall plugs through the use of electrical junction boxes. Electrical junction boxes are typically mounted to the framing of a building, and are installed prior to the drywall or other wall application. In doing so junction boxes are often misaligned or have gaps or other deformities that make faceplates essential to cover the blemishes. Further, the gaps in the wall structure result in reduced building performance and increased energy loss. Electrical junction box faceplates cannot cure all issues with junction box installation. There remains a long sought need to improve the installation, alignment, mounting, and safety of electrical junction boxes.

### SUMMARY

In one aspect, a trim cover kit for installing electrical junction boxes to framing of a wall is disclosed. In the kit an electrical junction box is operatively configured for installation in an opening of a wall structure and secured to the framing of the wall structure. In that opening, an electrical outlet with terminal screws may be installed. The kit further comprises a trim cover with an interior surface, an exterior surface, a distal border capable of covering the opening in the wall structure, and a proximal border with an opening for the electrical outlet. The trim cover further comprises interior flashing on the sides of the proximal border to secure the trim cover within the opening in the wall structure and to guard against contact with the terminal screws as well to provide one or more alignment fastener points for fastening the trim cover to the electrical junction box. Continuing, the trim cover further provides one or more retaining screw guides located on the proximal border for securing the trim cover to the opening in the wall structure. Lastly, the kit comprises a faceplate configured to fasten to the electrical outlet.

### BRIEF DESCRIPTION OF THE DRAWINGS

Many aspects of the present disclosure can be better understood with reference to the following drawings. The components in the drawings are not necessarily to scale. Rather, emphasis is instead being placed upon clearly illustrating the principles of the disclosure. Moreover, in the drawings, like reference numerals designate corresponding parts throughout the several views.

FIG. 1 is an illustration of an example embodiment of framing for an electrical junction box, and the electrical junction box and electrical outlet.

FIG. 2 is an illustration of an example embodiment of drywall installed around the electrical junction box of FIG. 1.

FIGS. 3A-C are illustrations of a trim cover, wherein FIG. 3A is a front perspective, FIG. 3B is a top view, and FIG. 3C is a side view.

FIG. 4 is an illustration of an example embodiment of a trim cover kit installation overview.

FIG. 5 is an illustration of an example embodiment of a trim cover kit being installed.

FIG. 6 is an illustration of an example embodiment of the leveling and tightening of the fasteners of a trim cover kit.

FIG. 7 is an illustration of an example embodiment of an installed trim cover kit with a standard faceplate cover.

FIG. 8 is an illustration of an example embodiment of an installed trim cover kit with a jumbo or large faceplate cover.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting, but are examples of embodiments of the disclosure herein. Other embodiments may be utilized, and other changes may be made, without departing from the scope of the subject matter presented herein. It will be readily understood by those with skill in the art that the aspects of the present disclosure, as generally described herein, and illustrated in the figures, can be arranged, substituted, combined, separated, and designed in a wide variety of different configurations, all of which are explicitly contemplated herein.

Electrical junction boxes are designed to contain a variety of electrical outlets and switches. Today, the standard electrical outlets are being adapted to include combination outlets and receptacles that may include USB technology and or smart technology for powering devices. The smart technology may include WiFi and other features such as built in safety monitoring. Further, junction boxes may house outlets such as GFCI, AFCI, light switches, combination outlets, tamper resistant features, and many more improvements. As these new technologies change the size and dimensions afforded for electrical junction boxes contractors and builders must be prepared for designing and installing the circuitry. Inevitably the variables of sizing and fitting electrical junction boxes will create gaps within the wall space. Such gaps may cause energy loss to the building or provide for unsightly appearance such as an askew outlet or gap within the wall. Further, such gaps may expose the terminal screws or other elements such as bare wire and increase the risk of injury to the consumer. The disclosure herein remedies these ailments and provides a low-cost and effective solution for installation of electrical junction boxes.

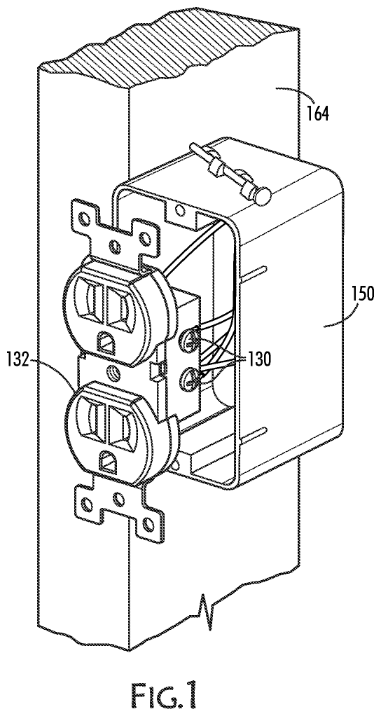

We begin our review of the drawings with FIG. 1, an illustration of an example embodiment of an electrical junction box with an outlet. In the illustration a duplex electrical outlet 132 is depicted. Electrical outlets and switches come in a variety of sizes and colors, and may be rated for 15 amp, 20 amp, or other amperage as displayed on most packaging. Leviton™ amp 125 volt duplex tamper-resistant outlet (https://www.leviton.com/en/products/residential/outlets) is one such example of an electrical outlet manufacturer, many other manufactures exists, as well as a plethora of styles that are compatible with the trim cover kit disclosure herein.

Electrical outlets, as disclosed in FIG. 1 typically have terminal screws 130 on the side of the outlet and wire holes (not depicted) for solid wire installation in the back of the electrical outlet 132. The electrical junction box 150 or simply junction box is sized to fit the electrical outlet 132 based on the installation needs. Most electrical junction boxes are in a standard range of sizes (1 single, 2 gang, 3 gang, and 4 gang), with some degree of variability depending upon the construction of the junction box. There is a wide variety of shapes and materials that may offer subtle benefits such as having more resilience and or tamper protection, as well as fire protection. For example, junction boxes may be constructed from polymers, fiberglass, and/or metals. With metals the junction boxes are typically constructed from steel or other low cost metal, with outdoor options including weatherproof junction boxes made from aluminum or anodized metals. Polymer junction boxes may be constructed from PVC or other polymeric compound that expresses beneficial properties and lower cost. Lastly, electrical junction boxes are manufactured in a variety of shapes, sizes, and depths, including round pan, octagon, rounded square, square, ceiling fan related, and more.

The framing 164 is typically comprised of wood or metal and is the foundation of the walls in most structures. The framing may also be comprised of a composite or a polymer. The framing provides rigidity and the ability to receive and hold the electrical junction box 150. Typically, a nail on the bottom and top will hold a junction box tight to the framing. In other embodiments the electrical junction box may be held in place by carriers, screws, adhesives, or other materials that form a tight and secure fit to the framing 164. The wiring for electrical boxes is typically done when the framing 164 is installed and prior to the installation of a wall structure. The problem is created when the wall structure is cut or fitted to the framing, wherein the installer makes imprecise cuts that allow for gaps and or deformations in the wall structure. Such deformations give rise to energy loss and unsightly appearance, amongst other things as discussed herein.

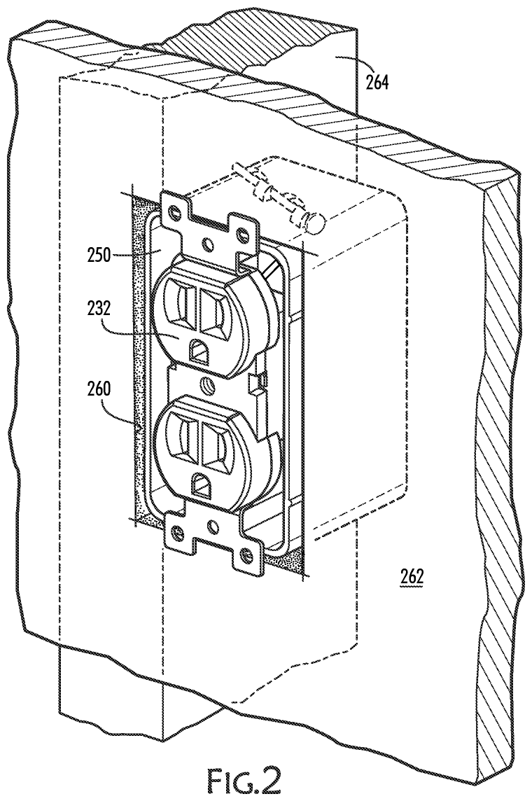

Referring now to FIG. 2, an illustration of an example embodiment of drywall installed (wall structure) around the electrical junction box of FIG. 1 The drywall, referred to herein as wall structure 262, is fastened to the framing 264 and held in place by screws, nails, adhesives or other fasteners. The wall structure 262 has a wall opening 260 that is typically formed by a worker cutting an opening with a sharp tool at the approximate location of the electrical junction box 250. The cut is often an estimate and consistency across the installation is highly dependent upon the worker/installer and the skill he or she possesses. The electrical outlet 232 is then installed into the electrical junction box 250 thus completing a typical installation without the use of a trim cover kit.

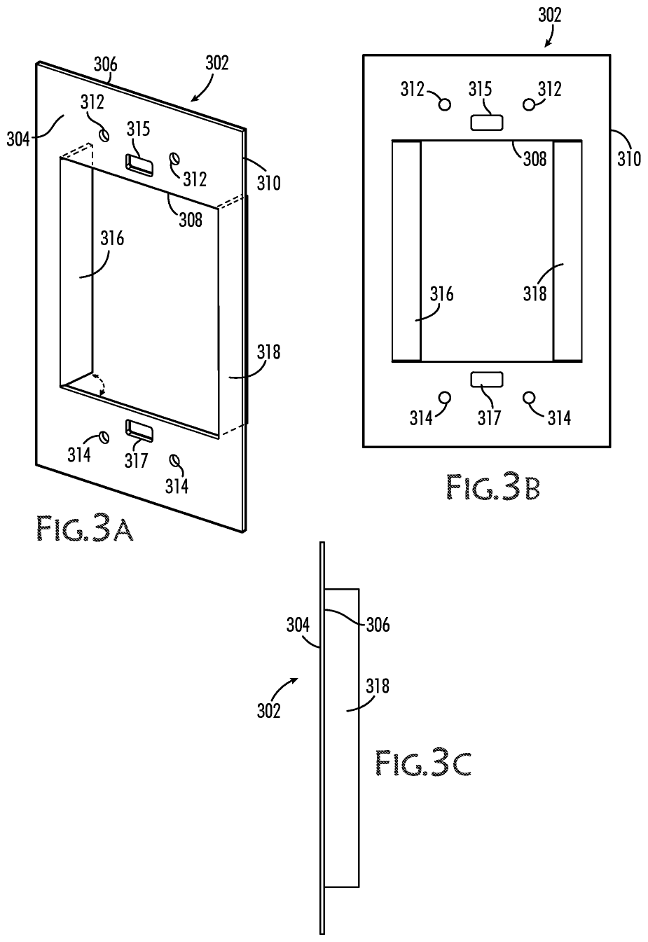

Turning to FIGS. 3A-C for illustrations of a trim cover, wherein 3A is a front perspective, 3B is a top view, and 3C is a side view. In FIG. 3A a front perspective view that, altogether, discloses the various features of a trim cover 302. The trim cover 302 is comprised of an interior surface 306 and an exterior surface 304. The interior surface 306 may have ridges or texture to improve connection and contact with the wall and eliminate sliding or shifting. The exterior surface 304 is typically smooth but may also have a ridge, if an oversized plate is used, such as a jumbo plate, the trim cover may have ridges to align the plate on the exterior surface 304.

The trim cover includes several foramens. Starting from the top of the trim cover, the top alignment fastener points 312 align with the wings which are standard features of electrical outlets—in particular the metal frame, wherein the alignment fastener points serve as fastener locations. The top retaining screw guide 315 is aligned with the guide screw of an electrical outlet and allows for correction of alignment. The outside edge of the trim cover 302 consists of the distal border, and directly opposite is the proximal border 308. The distal border 310 may consist of a slight slope such as a 18 degree slope or may be rounded, or in other example may have a hard edge—such as a 90 degree bend. The various distal border examples indicate that the border may be adapted to particular circumstance, for instance, a sloped border may allow for a more streamlined appearance with the wall, whereas a rounded border or 90-degree edge may show distinctiveness.

The next feature of the trim cover 302 is the proximal flashing 316 and 318. The proximal flashing 316 and 318 provide insulation as well as safety and security from the outlet terminal screws. The proximal flashing 316 and 318 may be made of the same material as the trim cover 302, or may be comprised of material that provides increased thermal insulation or electrical insulation from the terminal screws. The trim cover 302 may be comprised from a metal such as a galvanized steel or may be constructed from a polymer like polyvinyl chloride (PVC), or other materials such as wood, and cardboard. The material may be manufacture from a stamping process, or may be molded, or extruded through a die.

Continuing with FIG. 3, the bottom alignment fasteners 314 perform a similar function to the top alignment fasteners, namely, to align with the points of the electrical outlet. Lastly, the bottom retaining screw guide 317 is aligned with the retaining screw of the electrical outlet and an anchor point in the electrical junction box (not depicted in FIG. 3). The bottom retaining screw guide 317 works in coordination with the top retaining screw guide 315 to assist in alignment and in securing the trim cover and the outlet to the electrical junction box. One skilled in the art will recognize the immediate benefits of the disclosure herein, as the trim cover allows the secure fit and correction of defects in the fitting of an electrical junction box and wall structure.

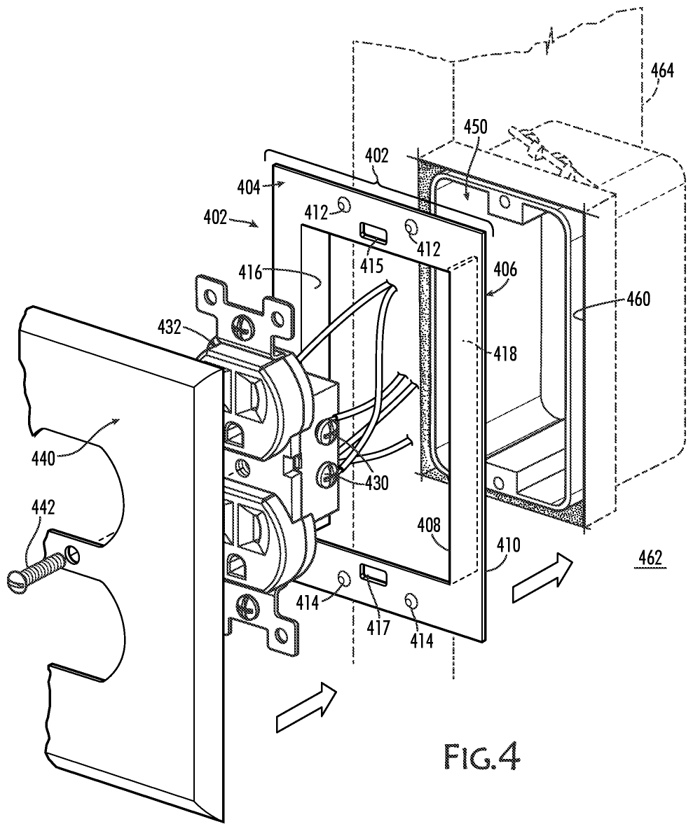

Referring now to FIG. 4 an illustration of example embodiment of a trim cover kit installation overview. The trim cover kit 462 includes a trim cover 402 that is manufactured and designed in various sizes and shapes to handle the multitude of dimensions in electrical outlets and switches, as well as to provide an installation platform, or kit, that facilitates leveling and aligning, as well as providing insulation and electrical safety features.

One such safety feature is to provide proximal flashing 416 and 418 that prevents user contact with the terminal screws 430. Another safety feature is to provide a gasket, such as a rubber compound, for the electrical junction box 450 so as to prevent debris or other material from accumulating and potentially posing a fire or an electrical shock hazard. An additional aspect of the proximal flashing 416 and 418 is providing a sealing or barrier for cold air flow from the wall opening, wherein the wall may not be insulated well, and may cause significant energy drain in the residential or commercial building. Lastly, the proximal flashing provides a weather barrier and may be used in combination with a rubber compound being applied to the proximal border and/or distal border or flashing to seal the electrical junction box 450 from water, snow, ice, and debris.

In the example embodiment of FIG. 4 the electrical junction box 450 is secured to the framing 464 using two nails (one top and one bottom). A wall opening 460 grants access to the electrical junction box 450 wherein the electrical outlet 432 will be installed. The trim cover 402 is secured over the electrical junction box 450 and has top alignment fastener points 412, as well as bottom alignment fastener points 414 wherein as depicted the top and bottom fastener points fit guides in the electrical outlet 432. The top retaining screw guide 415 as well as the bottom retaining screw guide 417 receive the retaining screws from the electrical outlet 432. The retaining screws are depicted in this example as Phillips head screws at the top and bottom of the electrical outlet 432. The terminal screws 430 receive the load wire and the neutral wire, and a grounding screw or terminal is typically found on the opposite side or the back of the electrical outlet 432. The exterior surface 404 of the trim cover 402 faces opposite the wall structure and covers the wall opening 460. The interior surface 406 of the trim cover 402 faces towards the wall structure and covers the wall opening 460. The interior surface 406 may be smooth or texturized or may have paint or other additives placed on it during manufacture that may yield benefits, such as a foam adhesive for securing against the wall structure or a fire retardant chemical such as PentaBDE, TDCPP, FireMaster™ 550, V6, TBPP, MPP Mix, TCPP.

An example installation process of a trim cover kit from the early stages of building is highlighted in the following steps:
i. Framing installation
ii. Electrical junction box installed to framing
iii. Drywall (wall structure) placement
iv. Drywall (wall structure) scored and cut for the electrical junction box
v. Trim cover aligned and installed on drywall (wall structure) over electrical junction box
vi. Electrical outlet secured to trim cover and the electrical junction box
vii. Faceplate fastened to the electrical outlet

An example of the installation process of a trim cover kit with respect to a previously-installed electrical junction box, electrical outlet, and faceplate is highlighted in the following steps:
i. Turning off power to the location
ii. Removing the faceplate
iii. Removing the outlet
iv. Installing the trim cover, aligning and setting to the wall structure and electrical junction box
v. Reinstalling the outlet to the trim cover
vi. Reinstalling the faceplate to the outlet

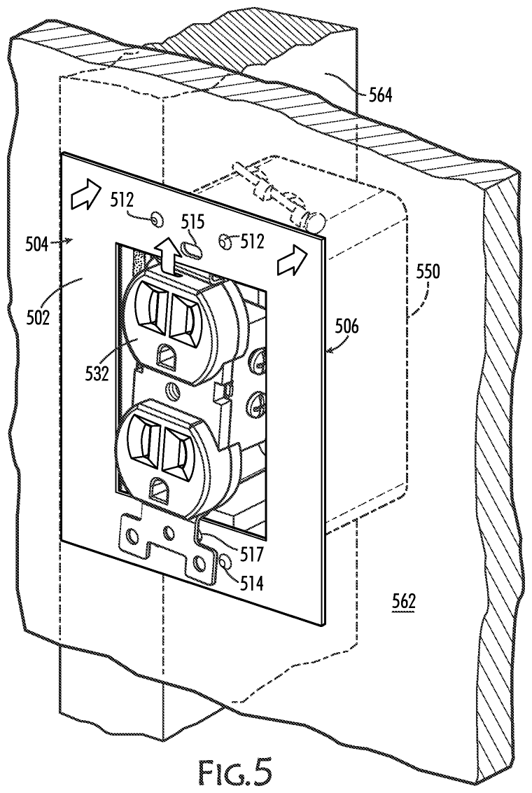

Referring now to FIG. 5, an illustration of an example embodiment of a trim cover kit being installed. In this example, the framing 564 is depicted with a wall structure 562 already in place with the trim cover 502 secured to the wall structure, the trim cover 502 having an exterior surface 504 and an interior surface 506. The electrical outlet 532 is secured on the top alignment fasteners 512 and bottom alignment fasteners 514 whereas to align the top retaining screw guide 515 and bottom retaining screw guide 517 for securing the electrical outlet 532 to the electrical junction box 550.

In the example, the trim cover 502 is depicted with projected surfaces for the top and bottom alignment fasteners 512 and 514. In other examples the top and bottom alignment fasteners are foramens that allow additional fasteners to be applied. In other examples the top and bottom alignment fasteners may be removed and only the retaining screw guides may be used in securing the trim cover 502, the electrical outlet 532, and the electrical junction box 550.

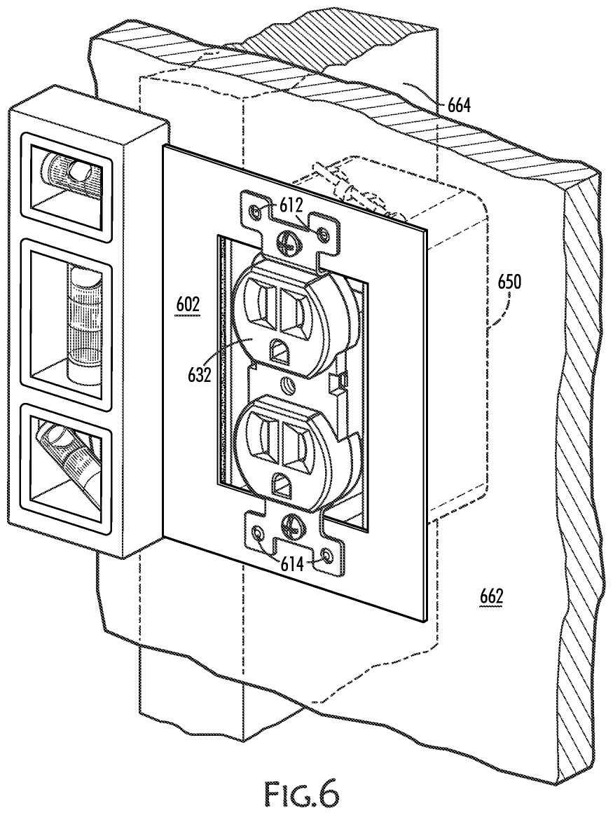

In the example of FIG. 6 the trim cover 602 is mounted and aligned to the wall structure 662 to correct misalignment of the electrical junction box 650. The trim cover 602 has alignment fastener points 612 and 614 (that may be raised or open foramen) to secure and align the trim cover 602 to the wall structure 662. The electrical junction box 650 is secured to the wall support structure or framing 164. The recess for the electrical junction box often creates gaps within the wall structure 662 of which may cause thermal energy loss. The distal and proximal border of the trim cover 602 is designed to cover the gaps in the wall structure 662, and the proximal border is configured to receive the electrical outlet 632 or other electrical devices such as a light switch, GFCI, AFCI, and combination outlets as discussed as examples herein.

In the example embodiment the trim cover 602 is comprised of a sheet metal such as a galvanized steel metal. As discussed previously, in other embodiments the trim cover 602 is comprised of a polymeric material (PVC), or a rubber synthetic, or of a fibrous paper material such as a sturdy cardboard, or it may be comprised of wood. The material may have a paintable surface for occasions when the gap in the wall structure 662 is so large the faceplate (not depicted) will not cover the opening and the trim cover 602. Further, the interior surface of the trim cover 602 may have ridges or texture to enable a higher degree of friction against the wall structure 662 to prevent movement. Further the interior surface, including the distal and proximal borders may be coated in flame retardant material or may be dipped in a rubber compound or possess a further rubber compound sealant for securing and weatherproofing the trim cover 602. The exterior surface may have a tapered design at the edges or a bevel and may be designed to transition into the wall structure or with a more abrupt curve.

In the example of FIG. 6 the trim cover 602 is equipped with several points for securing and fastening the trim cover to either the wall structure 662 or the electrical junction box 650, or both. The trim cover 602 alignment fastener points 112 and 114 are located on the top and bottom regions of the trim cover 602 and in the example embodiment are aligned with tabs or points on the electrical outlet 632. Thereby allowing the electrical junction box 650 to be skewed but the trim cover 602 leveled and aligned with the wall structure 662 and thereby compensate and correct for misaligned electrical junction boxes 650 and wall openings in the wall structure 662.

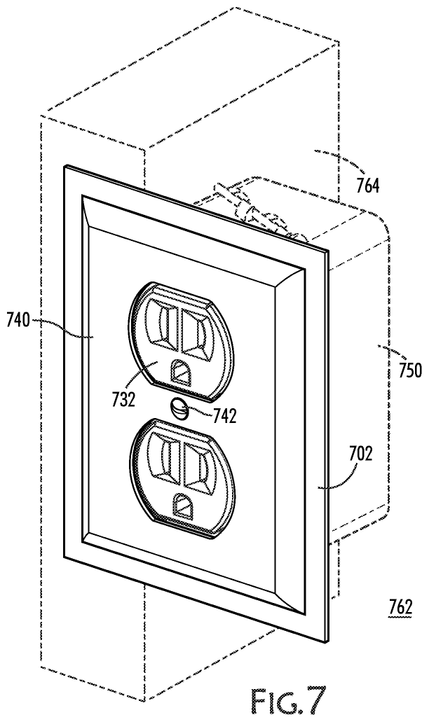

Referring now to FIG. 7, the faceplate 740, which is sometimes referred to as a wall plate or wall cover, is available in a variety of shapes, colors, and sizes. Faceplate sizes typically range from small, medium, large and oversized to allow for gap coverage in the wall structure surrounding the electrical junction box 750. The trim cover 702 avoids the need for multiple faceplate sizes as it covers the electrical junction box. The economic impact of the trim cover 702 is highlighted in the provisional application and cross referenced herein, where the contents of such is hereby incorporated by reference. Further, the trim cover 702 may be painted the color of the wall or may be manufactured with a specific color, texture, and material to meet the consumers need.

Continuing with FIG. 7, the faceplate is held into position by a faceplate retaining screw 742 and has openings for the electrical outlet 732. In other examples a faceplate may have a universal serial bus (USB) enabled electrical outlet, wherein the faceplate will have openings for access to the outlet receptacles and the USB receptacles. The faceplate 740 is a standard size and is more affordable over jumbo or other sized faceplates. If standardized in size, the trim cover 702 alleviates the need to buy an array of faceplates and further provides the added benefits as disclosed herein.

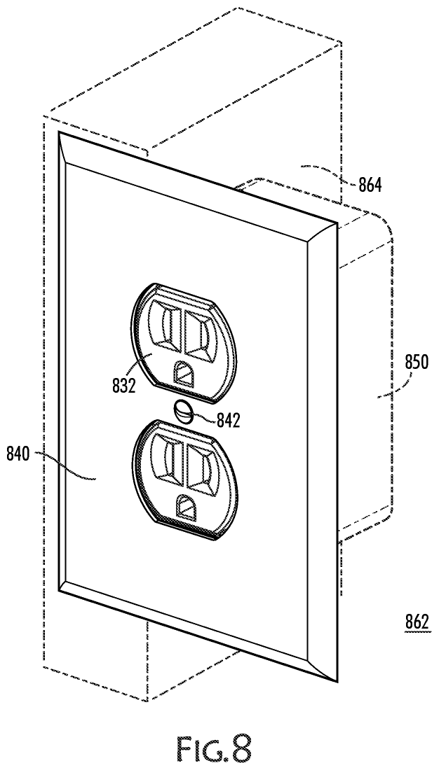

Referring now to FIG. 8, an illustration of an example embodiment of an installed trim cover kit with a jumbo or large faceplate cover. The jumbo faceplate 840 is depicted completely covering the trim cover. The jumbo faceplate 840 is secured to the electrical outlet 832 through the faceplate retaining fastener 842 and/or faceplate retaining screw. The electrical junction box 850 is secured to the framing 864. The jumbo faceplate oftentimes costs significantly more than the standard and does not provide flashing for safety and or gaskets to seal the electrical outlet 832. The jumbo faceplate is also typically more fragile and is susceptible to breaking from a force applied where the gap in the wall structure is. Further, the jumbo faceplate lacks insulation, and therefore cold air flow can penetrate through the wall at the wall opening and cause increased energy costs for the residence or commercial building.

It should be emphasized that the above-described embodiments of the present disclosure are merely some of the examples of implementations set forth for a clear understanding of the principles of the disclosure. Many variations and modifications may be made to the above-described embodiments without departing substantially from the scope and principles of the disclosure. All such modifications and variations are intended to be included herein within the scope of this disclosure and protected by the following claims.

Therefore, the following is claimed:

1. A trim cover kit for installing electrical junction boxes to framing of a wall, comprising:
an electrical junction box operatively configured to be installed in an opening in a wall structure and secured to framing of the wall structure;
an electrical outlet;
a trim cover, comprising:
an interior surface;
an exterior surface;
a distal border capable of covering the opening in the wall structure;
a proximal border with an opening for the electrical outlet, the proximal border having sides;
proximal flashing on the sides of the proximal border to secure the trim cover within the opening in the wall structure and to protect against contact with wiring and/or terminal screws;
one or more retaining screw guides for fastening the trim cover to the electrical junction box;
one or more alignment fasteners located near the proximal border of the trim cover for securing the trim cover to the electrical outlet; and
a faceplate cover configured to fasten to the electrical outlet.

2. The trim cover of claim 1, further comprising a beveled edge portion on the distal border.

3. The trim cover of claim 1, further comprising a paintable exterior surface.

4. The trim cover of claim 1, wherein the trim cover is comprised of a metal.

5. The trim cover of claim 1, wherein the trim cover is comprised of a polymeric material.

6. The trim cover of claim 1, wherein the trim cover is comprised of a paper material.

7. The trim cover of claim 1, wherein the trim cover is comprised of a wood material.

8. The trim cover of claim 1, further comprising a level indicator.

9. The trim cover of claim 1, wherein the interior surface has an adhesive applied.

10. The trim cover of claim 1, wherein the interior surface and the proximal flashing has a rubber compound applied for weatherproofing.

11. The trim cover of claim 1, wherein the electrical outlet is for an electrical lighting switch.

12. The trim cover of claim 1, further comprising ridges on the interior surface of the trim cover that provides stability against the wall structure.

13. The trim cover of claim 1, wherein the proximal flashing is provided along the proximal border and further reduces cold air flow.
